(19) United States
(12) Patent Application Publication
(10) Pub. No.: US 2013/0040058 A1
(43) Pub. Date: Feb. 14, 2013

(54) FORMULATION SUITABLE FOR USE AS AN ANTI-GRAFFITI COATING HAVING IMPROVED COVERAGE PROPERTIES

(71) Applicants: Manuel Friedel, Zuerich (CH); Spomenko Ljesic, Rheinfelden (DE)

(72) Inventors: Manuel Friedel, Zuerich (CH); Spomenko Ljesic, Rheinfelden (DE)

(73) Assignee: Evonik Degussa GmbH, Essen (DE)

(21) Appl. No.: 13/638,702

(22) PCT Filed: Feb. 14, 2011
(86) PCT No.: PCT/EP2011/052110

§ 371 Date: Oct. 25, 2012

(30) Foreign Application Priority Data
Apr. 1, 2010 (DE) 102010003579.3

(51) Int. Cl. C09D 183/08; B05D 3/00; B05D 1/02; C08K 3/36

(52) U.S. Cl. 427/379; 524/500; 427/387

(57) ABSTRACT

The invention relates to a composition suitable for producing anti-graffiti coatings, comprising substantially water-soluble and substantially fully hydrolyzed oligomeric organosiloxanes and at least one polyoxyalkylene block copolymer as a coverage agent and water, to a method for producing same, and to the use thereof. The compositions according to the invention comprise improved film formation properties evident in that cohesive films can be generated during application, such as on porous mineral substrates, without forming droplets.

The invention relates to a composition suitable for producing antigraffiti coatings and comprising substantially water-soluble and substantially fully hydrolyzed, oligomeric organosiloxanes, and at least one polyoxyalkylene block copolymer as wetting agent, and water, and also to methods for producing it, and also to the use thereof. The compositions of the invention feature enhanced film-forming properties, which are manifested in the capacity for coherent films to be generated, without formation of droplets, on application for example—but not exclusively—to porous, mineral substrates, to name only one of the particularly preferred application possibilities.

The use of water-based, oligomeric organosiloxanes with fluorinated alkyl groups as an antigraffiti coating is general knowledge. A problematic element which has emerged in the use of these aqueous formulations is their film-forming properties. Thus, when the known water-based antigraffiti formulations are applied, coherent films are not formed, and there is formation of droplets. Consequently, even formulations applied by spray application must be spread with a brush to form a continuous film, and this is costly and inconvenient. Accordingly, for example, the droplets applied by spraying in example 1 of EP 1 193 302 A2 have to be aftertreated with a brush in order to form a homogeneous film. Untreated droplets tend frequently to form sticky films of silicone resin. Particularly in the protection of buildings, with the extensive surface areas that are encountered there, a costly and inconvenient brush aftertreatment is therefore undesirable.

There continues, therefore, to be a need for water-based and VOC-reduced compositions of oligomeric organosiloxanes which have improved film-forming properties than the known systems and at the same time retain their hydrophobizing and oleophobizing effect.

It was an object of the invention to provide water-based compositions of oligomeric organosiloxanes that are suitable as an antigraffiti coating and that have improved film-forming properties when the composition is applied to a substrate. A further object was to indicate a method for producing these compositions.

The objects are achieved in accordance with the invention in accordance with the details in the claims. The object is achieved more particularly by the composition of the invention, corresponding to the features of claim 1, and also by the production method of the invention, according to claim 11. Preferred embodiments are set out in the dependent claims and also in the description.

Surprisingly it has been possible to achieve the object with compositions of water-based, low-VOC oligomeric organosiloxanes which comprise very specific wetting agents, and which, by virtue of this modification, can be applied by spraying as coherent films to substrate surfaces without forming sticky droplets—even after multiple application.

Compositions of the invention comprise substantially water-soluble and substantially fully hydrolyzed, oligomeric organosiloxanes, at least one wetting agent based on polyoxyalkylene block copolymers, more particularly on ethylene oxide-propylene oxide-ethylene oxide (EO/PO/EO) triblock copolymers, and water, in which the organosiloxanes or mixtures of these are present in the form of cocondensates or block cocondensates and are derived from at least two of the alkoxysilanes of the general formulae II, III, IV, and V, and on crosslinking no longer release substantially any alcohol. The organosiloxanes obtained from the alkoxysilanes by hydrolysis and/or condensation in the presence of a defined amount of water and optionally of an acid, after removal of the hydrolysis alcohol and optional addition of water, can be prepared preferably as disclosed in EP 0 846 717 and EP 1 193 301 A2. The disclosure content of EP 0 846 717 and EP 1 193 301 A2 is made entirely part of the content of the present invention.

The invention accordingly provides a composition comprising substantially water-soluble and substantially fully hydrolyzed, oligomeric organosiloxanes, at least one wetting agent, and water, and

(i) a) in which at least one organosiloxane or a mixture of the organosiloxanes is or are derived from alkoxysilanes of the formulae II, III, IV and/or V and has or have crosslinking structural elements which form catenary, cyclic, crosslinked and/or three-dimensionally crosslinked structures, with at least one structure corresponding in idealized form to the general formula I,

(HO)[(HO)₁₋ₓ(R²)ₓSi(A)O]ₐ[Si(B)(R³)_{y}(OH)_{1-y}O]_{b}[Si(C)(R⁵)ᵤ(OH)₁₋ᵤO]_{c}[Si(D)(OH)O]_{d}H·(HX)ₑ (I)

where in formula I the structural elements are derived from alkoxysilanes of the general formulae II, III, IV and/or V and
A corresponds to an aminoalkyl radical H₂N(CH₂)_{f}(NH)_{g}(CH₂)ₕ(NH)ₘ(R⁷)ₙ— in the structural element, derived from the general formula II,

H₂N(CH₂)_{f}(NH)_{g}(CH₂)ₕ(NH)ₘ(R⁷)ₙSi(OR¹)₃₋ₓ(R²)ₓ (II),
where f is an integer between 0 and 6, with g=0 if f=0 and g=1 if f>0, h is an integer between 0 and 6, x=0 or l, m=0 or 1 and n=0 or 1, with n+m=0 or 2 in formula II, and R⁷ is a linear, branched or cyclic divalent alkyl group having 1 to 16 C atoms,
B corresponds to a fluoroalkyl radical R⁴—Y—(CH₂)₂— in the structural element, derived from general formula III,

R⁴—Y—(CH₂)ₖSi(R³)_{y}(OR¹)_{3-y} (III),
where R⁴ is a mono-, oligo- or per-fluorinated alkyl group having 1 to 9 C atoms or a mono-, oligo- or per-fluorinated aryl group,
Y is a CH₂, O or S group, R³ is a linear, branched or cyclic alkyl group having 1 to 8 C atoms or is an aryl group, k=0, 1 or 2, and y=0 or 1 in formula III, preferably R⁴═F₃C(CF₂)ᵣ—, with r=0 to 18, preferably r=5, with Y a CH₂ or O group; and preferably k=1 with Y=—CH₂—,
C corresponds to an alkyl radical R⁶— in the structural element, derived from the general formula IV

R⁶—Si(R⁵)ᵤ(OR¹)₃₋ᵤ (IV),
in which R⁵ is a linear or branched alkyl group having 1 to 4 C atoms, more particularly methyl (CH₃—), and u=0 or 1 in formula IV,
D corresponds to an alkyl radical R⁶— in the structural element, derived from the general formula V,

R⁶—Si(OR¹)₃ (V),
in which R⁶ in the abovementioned formulae is a linear, branched or cyclic alkyl group having 1 to 8 C atoms, and
R¹ in formulae II, III, IV and/or V independently of one another is a linear, branched or cyclic alkyl group having 1 to 8 C atoms or is an aryl group, preferably R¹ independently is methyl, ethyl or propyl; with R², R³ and/or R⁵ in the abovementioned formulae correspond independently to a linear or branched alkyl radical having 1 to 4 C atoms, preferably independently methyl or ethyl, and
in formula (I) HX represents an acid, with X being an inorganic or organic acid radical, with x, y, and u independently of one another being 0 or 1, and a, b, c, d, and e independently of one another being integral with a≧0, b≧0, c≧0, d≧0, e≧0, and (a+b+c+d)≧2, preferably (a+b+c+d)≧4, with particular preference (a+b+c+d)≧10, with X comprising, for example, chloride, nitrate, formate or acetate,
   or (ii) in which the organosiloxanes are cocondensates or block cocondensates or mixtures of these derived from at least two of the aforementioned alkoxysilanes of the general formulae II, III, IV, and V, preferably in a molar ratio of the formulae II and II 1:≦3.5 derived or else with a, b c, and d in mol of the alkoxysilanes of the formulae II, III, IV and V with a molar ratio of 0.1≦[a/b+c+d)], more particularly 0.25≦[a/b+c+d)]≦6000, preferably 1≦[a/b+c+d)]≦3 with a >0, b>0, c≧0, d≧0, and
   (iii) the wetting agent is a polyoxyalkylene block copolymer or a mixture of such polyoxyalkylene block copolymers of at least two different alkylene oxide groups having in each case 1 to 8 C atoms, preferably those having in each case 1 to 5 C atoms, examples being unsubstituted or aryl-substituted—in the form of styrene oxide, for example—and/or alkyl-substituted alkyl oxide groups, and having a molecular weight in the range from 940 to 15 000, more particularly from 1000 to 15 000, or a mixture of these,
   (iv) and the composition on crosslinking no longer releases substantially any alcohol.

In accordance with the invention, when the aqueous composition is employed at an appropriate concentration, a hydrophobizing and oleophobizing effect is obtained. The composition suitably comprises oligomeric organopolysiloxanes with (a+b+c+d)≧4 and optionally monovalent inorganic or organic acids or derivatives thereof from the hydrolysis and/or condensation step of the alkoxysilanes, with the aqueous oligomeric organosiloxanes preferably having a pH between 1 to 8, preferably between 1 to 6, very preferably between 1 to 5. By derivative is meant compounds such as alkali metal halides, more particularly sodium chloride or potassium chloride, alkali metal acetates, alkyl formates, alkali metal nitrates or compounds of the aminoalkyl radical with inorganic or organic acid radicals, as shown in formula I. Structural elements are understood to be in each case the expressions in the square brackets, such as [Si(C)(R⁵)ᵤ(OH)₁₋ᵤO]_{c} or [(HO)₁₋ₓ(R²)ₓSi(A)O]ₐ or [Si(B)(R³)_{y}(OH)_{1-y}O]_{b} or [Si(D)(OH)O]_{d}H, which may be present in each case monomerically, oligomerically or polymerically as structural elements within the general organosiloxanes and also, preferably, of the formula I, and may be present unregulatedly, statistically or as a block within organosiloxanes, of the structural elements, and also within the general formula I. Overall, the organosiloxanes may have linear, branched, cyclic and/or three-dimensionally crosslinked structures and/or structural regions of the structural elements with M, D, T structures.

Organosiloxanes are considered to be substantially fully hydrolyzed when they have only a negligible content of hydrolyzable alkoxy groups, —OR¹—therefore not shown in idealized formula I, there shown as —OH. The content is considered negligible when it leads to a solvent content in the overall composition of below 5% by weight to 0% by weight or the detection limit.

With particular preference the polyoxyalkylene block copolymer comprises at least two different alkylene oxide groups, in the sense of substituted or unsubstituted divalent -alkyl-O— groups, in the general formula VI,

HO(EO)ᵥ—[Z]ᵣ—(EO)ᵥ—H (VI)

where Z is —CH(CH₃)—CH₂—O—, —(CH₂)₃—O—, —(CH₂)₄—O— or —CH(C₆H₆)—CH₂—O—, more preferably where Z is —CH(CH₃)—CH₂—O—, and EO in each case is —CH₂—CH₂—, v independently at each occurrence is an integer with a magnitude such that the hydrophilic part EO makes up 5 to 95 percent by weight of the block copolymer, and r is in each case an integer with a magnitude such that the hydrophobic part Z possesses a molecular weight of at least 450 g/mol.

In accordance with the invention the polyoxyalkylene block copolymer is a triblock copolymer of ethylene oxide blocks [EO], propylene oxide blocks [PO] and ethylene oxide blocks [EO].

Preferably, r in each case is an integer with a magnitude such that the hydrophobic part Z, more particularly with Z being —CH(CH₃)—CH₂—O—, of the polyoxyalkylene block copolymer possesses a molecular weight of between 450 to 3400, more particularly between 900 to 3400, g/mol, and v is in each case an integer with a magnitude such that the hydrophilic part EO, with EO being —CH₂—CH₂—O—, makes up about 10% to 90% by weight of the block copolymer. With particular preference, r is in each case an integer with a magnitude such that the hydrophobic part Z of the polyoxyalkylene block copolymer possesses a molecular weight in the range from 1100 to around 2300 g/mol, and v is in each case an integer with a magnitude such that the hydrophilic part EO makes up about 10% to 80% by weight of the block copolymer. With very particular preference, r is an integer with a magnitude such that the hydrophobic part Z of the polyoxyalkylene block copolymer possesses a molecular weight in the region of 1750 g/mol with plus/minus 50 g/mol, and v independently at each occurrence is in each case an integer with a magnitude such that the hydrophilic part EO makes up about 80% by weight with plus minus 10% by weight of the block copolymer.

The molecular weight is understood to be the average molecular weight and may be determined preferably via the hydroxyl number. The skilled person is sufficiently familiar with the method of determination (e.g., DIN 53240). Thus v independently at each occurrence may in the range from 10 to 500, more particularly between 10 to 300, preferably between 10 to 250, more preferably between 10 to 200, very preferably v in each case independently at each occurrence is between 40 to 100 or v is in each case around 70 with plus/minus 10. For r, numbers in the range from 10 to 100 are preferred, more particularly between 10 to 70, more preferably between 10 to 60, and very preferably r is around 30 with plus/minus 5.

The triblock copolymers used in accordance with the invention may be present in liquid or solid form. The molecular weight of the triblock copolymers is preferably between 940 to 10 000, more preferably between 1000 to 10 000. The molecular weights for the two ethylene oxide blocks here may amount to around 7000 to down to 980, 550, 500 or 400. The molecular weights of the propylene oxide blocks are preferably in the range from 450 to 3300, more particularly between 450 to 2726, more preferably between 950 to 2750, with particular preference around 950, 1100, 1750, 2300, 2750 or 3200, with v in each case independently at each occurrence being an integer and with the two ethylene oxide blocks making up between 10% to 90% by weight, preferably between 20% to 85% by weight with plus/minus 5% by weight, in relation to the overall polyoxyalkylene block copolymer. A preferred triblock copolymer may have the combination of on average v in each case independently being, or being around, 70±10 and r being 30±5.

In solid triblock copolymers, the molecular weights are preferably in a range from 4000 to 15 000, more particularly between 10 000 to 15 000, more preferably between 13 000 to 14 600. Examples of corresponding EO/PO/EO polymers have a molecular weight distribution of EO collectively 4000 and PO of 1000 with a molecular weight of 5000, or EO collectively 11 200 and PO of 4800 and collectively 16 000, or EO collectively 8500 and PO of 1500 and collectively of 10 000, or EO collectively 10 400 and PO of 2600 and collectively of 13 000, or else of EO collectively 11 680 and PO of 2920 and collectively of 14 600.

Depending on application it may also be preferable to have liquid and solid triblock copolymers present as a mixture/blend in the composition. Thus it is usefully possible to use 80% to 98% by weight of the liquid polymer and 2% to 20% by weight of the solid polymer in the overall composition of triblock copolymers, preference being given to 85% to 95% by weight of the liquid polymer and 5% to 15% by weight of the solid polymer, there being more preferably 88% to 92% by weight of the liquid polymer and 8% to 12% by weight of the solid polymer in a polyoxyalkylene block copolymer mixture.

In accordance with the invention the present composition is substantially free from volatile solvents, preferably from hydrolysis alcohol, and more particularly on crosslinking no longer releases any hydrolysis alcohol. The amount of organic solvents, more particularly volatile solvents, in the overall composition is preferably below 5% by weight to 0% or 0.0001% by weight, or down to the detection limit, with all constituents in the composition making 100% by weight in total. With particular preference the amount of organic solvents in the overall composition is between 3% to 0.0001% by weight, more particularly 1.0% to 0.0001% by weight, preferably between 0.5% to 0.0001% by weight or down to the detection limit. Volatile solvents are interpreted as alcohols, such as methanol, ethanol, isopropanol, n-propanol, and alkoxy groups which hydrolyze to alcohols, or methoxyethanol, which either are added to the formulation or are formed by hydrolysis of the alkoxysilanes, and also all further solvents known to the skilled person, such as ketones, ethers, and the like.

The active ingredient content of the composition, in terms of oligomeric organopolysiloxanes in the overall composition, is in accordance with the invention between 0.001% to 60% by weight, more particularly between 0.1% to 50% by weight, preferably between 0.5% to 30% by weight, more preferably 1% to 20% by weight, very preferably 1.5% to 15% by weight.

The amount of the wetting agent in the overall composition is preferably 0.001% to 5% by weight and also all values in between; more particularly the wetting agent is at least one polyoxyalkylene block copolymer or a mixture of these, preferably of a wetting agent of the general formula VI. The amount is preferably 0.01% to 3% by weight, in accordance with the invention 0.01% to 2% by weight, and may preferably be between 0.1% to 1% by weight. Further preferred amounts of the stated wetting agents are 0.1% to 2% by weight, more particularly 0.2% to 1.5% by weight, more preferably 0.25% to 1.5% by weight, very preferably 0.3% to 1% by weight.

For the modification of the coating formed, after application of a composition of the invention, this composition may advantageously be present—in order more particularly to increase its abrasion resistance and scratch resistance—inorganic particles, or fillers, such as silica, precipitated silica, pyrogenic silica, quartz, titanium dioxide, calcium carbonate, gypsum, ATH, alpha- and gamma Al₂O₃, magnesium hydroxide/oxide, iron oxides, clay minerals, phyllosilicates, cerium oxide, yttrium oxide, calcium oxide, zirconium oxide, hafnium oxide, boron oxide, gallium oxide, indium oxide, tin oxide, germanium oxide, and also corresponding hydroxides and oxid hydrates and also mixtures of at least two of the aforementioned compounds with one another or other metal-containing oxides familiar to the skilled person.

For producing the composition it is possible for the stated particles or fillers to be added as powder, paste or in aqueous dispersion optionally in stabilized dispersions. A composition comprising a silicon dioxide, a pyrogenic silica, a precipitated silica or mixtures of these has proved particularly advantageous in the case of spray application. In accordance with the invention, a pyrogenic silica or precipitated silica, more particularly as an aqueous dispersion or as aqueously dispersible pyrogenic or precipitated silica, is used in producing the composition.

In the overall composition, the amount of aforementioned inorganic particles or fillers, such as silicon dioxide, pyrogenic silica and/or precipitated silica, is between 0.001% to 10% by weight in relation to the overall composition, more particularly between 3% to 0.1% by weight, preferably between 2.5% to 0.2%, more preferably between 2% to 0.25% by weight. In this context, additionally, 0.6% to 0.02% by weight, 0.5% to 0.04% by weight, and, very preferably, 0.4% to 0.05% by weight of a content of silicon dioxide, pyrogenic silica and/or precipitated silica in relation to the overall composition is preferred. Preferred average particle sizes (primary particles) or aggregate sizes of the pyrogenic silica (d50) lie between 1 nm to 500 nm, preferably between 1 nm to 250 nm, more preferably between 1 nm to 150 nm.

Stabilized aqueous dispersions of pyrogenic silica that are used with preference have a content of 12% to 50% by weight in relation to the overall aqueous dispersion, with the particle sizes or sizes of the agglomerates present being typically between 30 to 300 nm.

Preferred compositions comprise organopolysiloxanes to an extent of 0.001% to 60% by weight, the wetting agent to an extent of 0.001% to 5% by weight, and optionally inorganic particles or fillers, such as silicon dioxide, pyrogenic silica and/or precipitated silica, to an extent of 0.001% to 10% by weight, in each case in relation to the overall composition, and water, more preferably demineralized water, to make up the composition to 100% by weight. The composition may usefully also comprise water-soluble solvent in small amounts.

A composition of the invention comprises for example 1% to 15% by weight of organopolysiloxanes, 0.01% to 2% by weight of the wetting agent, more particularly of the polyoxyalkylene block copolymer, preferably of the formula VI, optionally 0.1% to 3% by weight of inorganic particles or fillers, such as silicon dioxide, pyrogenic silica and/or precipitated silica, and also water, more particularly demineralized water, to make the composition up to 100% by weight.

The claimed compositions are substantially storage-stable. This means that they do not exhibit any visible changes such as hazing or sedimentation or gelling within two weeks, preferably 3 months, more preferably 1 year. In the case of sedimentation, the composition can be made homogeneously processable again by stirring.

Furthermore, the composition of the invention may comprise at least one other of the following components from the series of pigments, fillers, binders, crosslinkers, optical brighteners, coatings auxiliaries or other auxiliaries.

For the preparation of the aqueous and substantially fully hydrolyzed organo-siloxanes, and preferably VOC-free organosiloxanes, more particularly of the general formula I, it is preferred to use the following alkoxysilanes, hydrolyzed and/or condensed and made VOC-free:
as alkoxysilane of the formula II: aminopropyltriethoxysilane, aminopropyltri-methoxysilane or aminopropylmethyldiethoxysilane or aminopropylmethyl-dimethoxysilane, 1-aminomethyltrimethoxysilane, 1-aminomethyltriethoxysilane, N—[N′-(2-aminoethyl)-2-aminoethyl]-3-aminopropyltrimethoxysilane, N—[N′-(2-aminoethyl)-2-aminoethyl]-3-aminopropyltriethoxysilane, 2-aminoethyltrimethoxy-silane, 2-aminoethyltriethoxysilane, diaminoethylene-3-propyltrimethoxysilane, diaminoethylene-3-propyltriethoxysilane or mixtures thereof or aminoalkyl-alkoxysilanes substituted correspondingly by other alkoxy groups;
as alkoxysilane of the formula III: tridecafluoro-1,1,2,2-tetrahydrooctyl-1-trimethoxysilane or tridecafluoro-1,1,2,2-tetrahydrooctyl-1-triethoxysilane, 3,3,4,4,5,5,6,6,7,7,8,8,9,9,10,10,10-heptadecafluorooctyltriethoxysilane, 3,3,4,4,5,5,6,6,7,7,8,8,9,9,10,10,10-heptadecafluorooctyltrimethoxysilane, 3,3,4,4,5,5,6,6,7,7,8,8,8-tridecafluorooctylmethyltriethoxysilane and 3-(1,1,2,2-tetrafluoroethoxy)propyltriethoxysilane, 3,3,4,4,5,5,6,6,7,7,8,8,8-tridecafluoro-octylmethyltrimethoxysilane and 3-(1,1,2,2-tetrafluoroethoxy)propyltrimethoxy-silane or mixtures thereof or fluoroalkylalkoxysilanes substituted correspondingly by other alkoxy groups or as disclosed in DE 196 44 561,
as alkoxysilane of the formula IV: dimethyldimethoxysilane, dimethyldiethoxysilane, propylmethyldimethoxysilane or propylmethyldiethoxysilane or mixtures thereof or correspond propoxy substituted silanes;
as alkoxysilane of the formula V: methyltrimethoxysilane, methyltriethoxysilane, ethyltrimethoxysilane, ethyltriethoxysilane, n-propyltrimethoxysilane, n-propyl-triethoxysilane, n- or isobutyltrimethoxysilane, n- or isobutyltriethoxysilane, n- or isooctyltrimethoxysilane, n- or isooctyltriethoxysilane, hexadecyltrimethoxysilane, hexadecyltriethoxysilane.

The preparation of the organosiloxanes takes place for example—but not exclusively—in accordance with a method of the kind described in EP 0 846 717 A2 or EP 1 193 302 A2 and more particularly also with the molar ratios disclosed therein for the alkoxysilanes used. Accordingly, reference is made in its entirety to the disclosure content of EP 0 846 717 A2 and EP 1 193 302 A2, and it is made subject matter of the present application.

The invention also provides a method for producing a composition, and also a composition obtainable by this method, by mixing
aqueous, substantially water-soluble, and substantially fully hydrolyzed, oligomeric organosiloxanes, comprising at least one organosiloxane or a mixture of the organosiloxanes which are derived from alkoxysilanes of the formulae II, III, IV and/or V, more particularly as identified in claim 1, and have crosslinking structural elements which form catenary, cyclic, crosslinked and/or three-dimensionally crosslinked structures, with preferably at least one structure corresponding in idealized form to the general formula I, or organosiloxane cocondensates, block cocondensates or mixtures of these derived from at least two of the stated alkoxysilanes of the general formulae II, III, IV, and V
   with
a polyoxyalkylene block copolymer or a mixture of polyoxyalkylene block copolymers comprising at least two different alkylene oxide groups having in each case 1 to 8 C atoms, more particularly having 1 to 5 C atoms, as defined above, and having a molecular weight in the range from 450 to 15 000, preferably from 940 to 15 000, more preferably 1000 to 15 000, or a mixture of these.

With particular preference, aqueous, oligomeric organosiloxanes, more particularly aminoalkyl-, aminopropyl-/methyl- and fluoroalkyl-functional organosiloxanes, are mixed with a triblock copolymer or with a mixture of these polymers and optionally with silicon dioxide, such as precipitated silica or pyrogenic silica. Mixing may be accomplished by separate or joint stirred incorporation of the polymers and/or of the silicon dioxide into the aqueous organosiloxanes. Preferably, of the silicon dioxide, an aqueous dispersion or an aqueously dispersible pyrogenic or precipitated silica is mixed with an aqueous organosiloxane containing composition. Through the use of aqueous dispersions or of aqueous, dispersible pyrogenic silicas or precipitated silicas it is possible in general to avoid laborious homogenization at high stirring speeds. Thus, with particular preference, it is possible to use an alkali-stabilized pyrogenic silica with a content of 10% to 50% by weight in the aqueous dispersion, preferably around 20±1% by weight in relation to the dispersion. The viscosity of this dispersion is set advantageously at less than or equal to 300 m Pa s (measured at shear rates of 100 s⁻¹ measured in accordance with DIN EN ISO 32 19) and the pH is in the range from 9 to 10. Present as stabilizer may be for example—but not exclusively—potassium hydroxide. The average aggregate size of the pyrogenic silica particles may be as elucidated above. With particular preference, an aqueous dispersion of a pyrogenic or other silica, aqueously dispersible pyrogenic or other silica or powder-form pyrogenic or other silica is added to the organosiloxanes. The amount of silicon dioxide, pyrogenic silica and/or precipitated silica in relation to the overall composition is set to the values described above.

In accordance with the invention a polyoxyalkylene block copolymer or a mixture of polyoxyalkylene block copolymers is mixed with the organosiloxane, where the polyoxyalkylene block copolymers have at least two different alkylene oxide groups of the general formula VI,

HO(EO)ᵥ—[Z]ᵣ—(EO)ᵥ—H (VI)

where Z is —CH(CH₃)—CH₂—O—, —(CH₂)₃—O—, —(CH₂)₄—O— or —CH(C₆H₆)—CH₂—O— and EO is —CH₂—CH₂—, v independently at each occurrence is an integer with a magnitude such that the hydrophilic part EO makes up 5 to 95 percent by weight of the block copolymer, and r is an integer with a magnitude such that the hydrophobic part Z possesses a molecular weight of at least 450 g/mol. With further preference, the above-elucidated triblock copolymers with the stated molecular weights overall or of the PO, EO blocks, v, r and/or weight percentages of EO blocks may be used in the block copolymers. Particularly preferred in this context are polyoxyalkylene block copolymers of the general formula VI in which r is an integer with a magnitude such that the hydrophobic part Z of the polyoxyalkylene block copolymer possesses a molecular weight in the region of 1750 g/mol with plus/minus 50 g/mol, and v independently is an integer with a magnitude such that the hydrophilic part EO makes up about 80% by weight with plus minus 10% by weight of the block copolymer. The polyoxyalkylene block copolymers used for producing the composition may preferably also have EO parts differing in their length. The values of the numbers of the two v in formula VI are independent of one another and may therefore differ significantly.

Generally, however, for producing the composition, it is also possible for the organosiloxane to be incorporated with stirring into an aqueous pyrogenic or precipitated silica dispersion, with the subsequent stirred incorporation of the polyoxyalkylene block copolymers. Alternatively, an aqueous dispersion of a pyrogenic or precipitated silica may first be incorporated with stirring into aqueous organosiloxanes, and then the polyoxyalkylene block copolymers are mixed therewith.

The compositions thus obtained may be diluted further preferably with water or usefully with a suitable solvent, and in this case, for application to inorganic materials, preferably porous inorganic substrates, such as concrete, lime sandstone, brick, paving slabs, more particularly to DIN 18 501, screed, granite, marble, sandstone, natural stone, an amount of 1% to 20% by weight of oligomeric organosiloxanes has emerged as being particularly preferred for an optimum result in terms of the film-forming properties and the oleophobic and hydrophobic effect.

Additionally, the compositions obtainable in accordance with the invention can be diluted in virtually any proportion with water, more particularly between 1:100 to 100:1 and also in all proportions lying in between.

The invention also provides the use of the composition of the invention or a method in which single to fourfold application to a substrate takes place, there being after each application a drying and/or crosslinking step, and the application taking place preferably by spraying. On being sprayed onto the surface for the first time, the composition may be applied in a more dilute form than on its second or further spray application. The spray application may be repeated as often as desired until the desired antigraffiti effect is attained.

Alternative application possibilities for the composition may include dipping, spreading, rolling, knifecoating, rubbing, polishing or flooding. In these cases, however, substantially coherent films are preferably formed on the substrates. Preferred droplet sizes are well below 200 μm, preferably less than 100 μm down into the nanometer range; alternatively, deposition and spincoating may be used for application to a substrate, or all further techniques known to the skilled person. For these purposes, a concentration of organosiloxanes in the composition that is suitable for the method employed is set. Depending on the processing method, therefore, the concentration of organosiloxanes may range from 0.01% by weight up to 99.5% by weight in the composition. The application methods are sufficiently well known to the competent skilled person in each case. Furthermore, in a way which is known per se, a coating applied to a substrate may set with the substrate or cure under ambient conditions and/or by means of an additional thermal and/or photochemical treatment. In this way, for example, with a composition of the invention, it is possible to treat inorganic or organic substrates, or a composition of the invention can be used as a starting component in formulations.

The invention also provides the use of a composition of substantially fully hydrolyzed, oligomeric organosiloxanes and polyoxyalkylene block copolymers and optionally silicon dioxides, precipitated silica or pyrogenic silica, based on water, more particularly as claimed in any of claims 1 to 15, for treating, modifying, producing formulations, substrates, articles, coatings, organic or inorganic materials or composite materials or for coating substrates, for hydrophobizing and oleophobizing and also dirt- and paint/ink-repellently treating surfaces or porous substrates, mineral building materials, metals, plastics, for protecting buildings and façades, for silanizing fillers and pigments, for improving the rheological properties of polymer dispersions and emulsions, for hydrophobizing and oleophobizing and also dirt- and paint/ink-repellently treating textiles, leather, glass fibers, cellulose products, and starch products, and also as release agent, as crosslinker, as adhesion promoter, and also as additives for inks, paints, and varnishes.

The end product obtained in accordance with the invention, or the composition of the invention, is generally liquid and of low to slight viscosity, the viscosity, more particularly for spray application, being below 1500 mPa s to 0.001 mPa s, preferably between 1000 and 1 mPa s, more preferably below 300 mPa s, preferably below 200 mPa s, more preferably below 100 mPa s, better still between 100 mPa s and 1 mPa s, more preference being given to ranges from 200 to 1 mPa s, more particularly of 100 and 10 mPa s (the viscosity is determined in accordance with DIN 53015).

The figures show coatings of inventive compositions and of comparative examples:

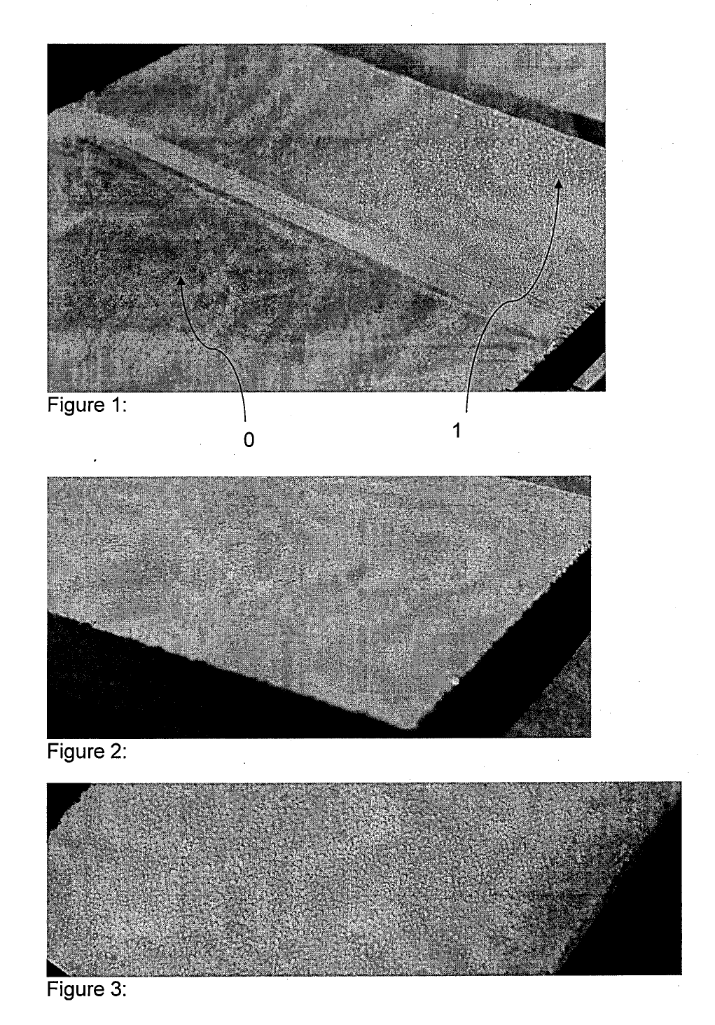

FIG. 1 shows a coating on a test specimen with unmodified organosiloxanes (1) and with the composition of the invention with wetting agent (0);

FIG. 2 shows a coating on a test specimen after twofold spray application with the composition of the invention;

FIG. 3 shows a coating on a test specimen after twofold spray application of a comparative example, corresponding to example 1, without wetting agent.

The examples below elucidate the present invention and also the compositions of the invention in more detail, without confining the invention to these examples.

### EXAMPLES

### Determination Methods

The alcohol content after hydrolysis is determined by gas chromatography. This is done by hydrolyzing a sample of a defined amount with sulfuric acid (5 g sample, 25 ml H₂SO₄, w=20%). 75 ml of distilled water are added. Then a neutralization is carried out using aqueous sodium hydroxide solution, and a steam distillation is conducted. Internal standard 2-butanol. Determination of SiO₂ takes place after decomposition by means of sulfuric acid and Kjeldahl catalyst, by determining the weight of the SiO₂ separated out. The viscosity is determined generally as elucidated above. Experiments for determining the stickiness are carried out using a method based on DIN 53150.

### Example 1

The preparation of an oligomeric, amino- and fluoroalkyl-functional organosiloxane may in accordance with example 1 of DE 19955047. This organosiloxane is a cocondensate of N—[N′-(2-aminoethyl)-2-aminoethyl]-3-aminopropyltrimethoxysilane and tridecafluorooctyltriethoxysilane in a molar ratio of 1:3, neutralized with 3 mol of formic acid per mole of aminoalkoxysilane used. The hydrolysis alcohol was removed by distillation and an active ingredient concentration of 15% by weight, based on the reaction product, was set by adding water.

### Example 2

### Preparation of the Formulation of the Invention

Mixing at room temperature of 99% by weight of the organosiloxane prepared in example 1 with 0.5% by weight of Pluronic® PE 6800 (triblock copolymer, EO/PO/EO from BASF) and 0.5% by weight of an aqueous dispersion (pH 9-10) comprising pyrogenic silica (around 20% by weight of the dispersion) in relation to the overall composition.

### Example 3

as example 2, but without addition of the pyrogenic silica.

These compositions were applied by spraying in two passes to concrete test specimens (concrete according to EN 196). The formulations prepared exhibit good stability and functionality with respect to the desired hydrophobizing and oleophobizing effect, more particularly as an antigraffiti coating.

### Comparative Example 1

### Application of the Formulation from Example 1

The wetting properties of the formulation of the invention become apparent in particular after the second spray application to concrete. After twofold spray application of the formulation of the invention—see FIG. 1—the applied formulation does not show any droplet formation (0), whereas a comparative composition at the same concentration without the wetting agent of the invention exhibits distinct droplet formation (1). Droplet formation (1) is clearly visible in the figure from the areas in which the light is more strongly reflected. The droplets formed are formed with a uniform distribution over the entire sprayed area. Their droplet size is on average 1 to 2 mm. FIG. 3 shows a corresponding coating on a test specimen after twofold spray application of a comparative example, corresponding to example 1, without wetting agent. Droplet formation is clearly visible. In the case of the comparative composition, then, a further operation would now be necessary, in order to eliminate the droplets using a brush or a decorating roller. The coating with the composition of the invention requires no such aftertreatment. In FIG. 2 the continuous film forming and uniform wetting of the test specimen—without droplet formation—after twofold spray application of the composition of example 2 is clearly visible. FIG. 3 shows a comparative composition—as per example 1, without wetting assistant—after twofold spray application with drying in between. FIG. 3 shows a distinct structuring of the treated surface as a result of the droplets which have formed and dried.

### Comparative Example 2

### Untreated Concrete

The examples in table 1 below show that the cleaning of customary graffiti inks and paints can be achieved with an excellent outcome if concrete is treated with mixtures according to the invention. A Cᵢ value of >80 is considered to be an excellent cleaning outcome. At the same time, the stickiness of the surface corresponds to that of the untreated comparison element.

TABLE 1

| | | Application rate | Surface | |
|---|---|---|---|---|
| Example | Substrate | [g/m²] | stickiness^{[1]} | Cᵢ value^{[2]} |
| 2 | * | 133 | 7 | 83 |
| 3 | * | 103 | 7 | 83 |
| Comparative | * | 107 | 6 | 87 |
| example 1 | | | | |
| Comparative | * | 0 | 7 | 0 |
| example 2 | | | | |

* Concrete slabs [15 × 7.5 × 1.5 cm] According to EN 196
^{[1]}Method based on DIN 53150 (2002-09)
^{[2]}For determining the Cᵢ values, the concrete slabs are sprayed with black Edding 800 permanent marker, flame-red RAL 3000 acrylic paint and high-gloss gentian blue Genius Pro Aqua spray paint. The three color spots are dried at room temperature for 60 minutes, then cleaned using an N-methylpyrrolidone (NMP) chemical cleaner. This is done by leaving the cleaner to act on the spray paint for 10 minutes, then rinsing off under running water and gently brushing at the surface. The specimens are subsequently dried at 60° C. for 15 minutes and cooled to RT. This procedure is performed a total of 10 times. The cleaning outcome is then assessed visually and a determination is made of the percentage removal of the individual paints/inks (removal without residue [symbol] 5 points, >90% [symbol] 4 points, 75% to 90% [symbol] 3 points, 30% to 75% [symbol] 2 points, <30% [symbol] 1 point). Using the point scores, the Ci value is calculated as follows: Cᵢ = (total points * 20)/3. At or above a Cᵢ value of 80, the cleaning outcome is considered to be excellent.

1. A composition, comprising:
a substantially water-soluble and substantially fully hydrolyzed, oligomeric organosiloxane,
a wetting agent, and
water,
wherein the wetting agent is a polyoxyalkylene block copolymer, or a mixture of polyoxyalkylene block copolymers,
each polyoxyalkylene block copolymer of the wetting agent comprises at least two different alkylene oxide groups,
each alkylene oxide group of the polyoxyalkylene block copolymer comprises from 1 to 8 C atoms,
each polyoxyalkylene block copolymer of the wetting agent has a molecular weight of from 940 to 15,000
the composition is configured to release no substantial amount of alcohol on crosslinking,
the organosiloxane is derived from an alkoxysilane, or is a cocondensate or block cocondensate derived from at least two alkoxysilanes,
the alkoxysilane or alkoxysilanes is or are of any of formulae II, III, IV, V, or any combination thereof:
H₂N(CH₂)_{f}(NH)_{g}(CH₂)ₕ(NH)ₘ(R⁷)ₙSi(OR¹)₃₋ₓ(R²)ₓ (II),
R⁴—Y—(CH₂)₂Si(R³)_{y}(OR¹)_{3-y} (III),
R⁶—Si(R⁵)ᵤ(OR¹)₃₋ᵤ (IV),
R⁶—Si(OR¹)₃ (V),
if the organosiloxane is derived from an alkoxysilane, the alkoxysilane comprises a crosslinking structural element that forms a structure that is catenary, cyclic, crosslinked, three-dimensionally crosslinked, or any combination thereof, with a structure of formula I:
(HO)[(HO)₁₋ₓ(R²)ₓSi(A)O]ₐ[Si(B)(R³)_{y}(OH)_{1-y}O]_{b}[Si(C)(R⁵)ᵤ(OH)₁₋ᵤO]_{c}[Si(D)(OH)O]_{d}H·(HX)ₑ (I),
the structural element is derived from alkoxysilanes of formulae II, III, IV, V, or any combination thereof,
A is an aminoalkyl radical H₂N(CH₂)_{f}(NH)_{g}(CH₂)ₕ(NH)ₘ(R⁷)ₙ— in the structural element, derived from formula II,
f is an integer between 0 and 6,
g=0 if f=0,
g=1 if f>0,
h is an integer between 0 and 6,
x=0 or 1,
m=0 or 1,
n=0 or 1,
n+m=0 or 2,
R⁷ is a linear, branched, or cyclic divalent alkyl group comprising from 1 to 16 C atoms,
B is a fluoroalkyl radical R⁴—Y—(CH₂)₂— in the structural element, derived from formula III,
R⁴ is a mono-, oligo- or per-fluorinated alkyl group comprising from 1 to 9 C atoms or a mono-, oligo- or per-fluorinated aryl group,
Y is a CH₂, O₃ or S group,
R³ is a linear, branched, or cyclic alkyl group comprising from 1 to 8 C atoms or is an aryl group,
y=0 or 1,
C is an alkyl radical R⁶— in the structural element, derived from formula IV,
R⁵ is a linear or branched alkyl group comprising from 1 to 4 C atoms,
u=0 or 1,
D is an alkyl radical R⁶— in the structural element, derived from formula V,
R⁶ is a linear, branched, or cyclic alkyl group comprising from 1 to 8 C atoms,
each R¹ is independently a linear, branched, or cyclic alkyl group comprising from 1 to 8 C atoms or is an aryl group,
R², R³, and R⁵ are each independently a linear or branched alkyl radical comprising from 1 to 4 C atoms, and
is an acid,
X is an inorganic or organic acid radical,
x, y, and u each independently are 0 or 1, and
a, b, c, d, and e are each independently integral with a≧0, b≧0, c≧0, d≧0, e≧0, and (a+b+c+d)≧2.

2. The composition of claim 1,
wherein the wetting agent is a polyoxyalkylene block copolymer of at least two different alkylene oxide groups of formula VI:
HO(EO)ᵥ—[Z]ᵣ—(EO), —H (VI)
Z is —CH(CH₃)—CH₂—O—, —(CH₂)₃—O—, —(CH₂)₄—O—, or —CH(C₆H₆)—CH₂—O—
EO is —CH₂—CH₂—,
each v is independently an integer with a magnitude such that a content of EO in the block copolymer is 5 to 95 percent by weight, and
r is an integer with a magnitude such that a molecular weight of Z is at least 450 g/mol.

3. The composition of claim 1,
wherein an organic solvent content of the composition is below 5% by weight to 0% by weight.

4. The composition of claim 1,
wherein an organopolysiloxane content of the composition is from 0.001% to 60% by weight.

5. The composition of claim 1,
wherein a content of the wetting agent of the composition is 0.001% to 5% by weight.

6. The composition of claim 2,
wherein r is an integer with a magnitude such that the molecular weight of Z is between 900 to 3400 g/mol, and
v is an integer with a magnitude such that the content of EO is about 10% to 90% by weight.

7. The composition of claim 2,
wherein r is an integer with a magnitude such that the molecular weight of Z is from 1700 to 1800 g/mol, and
v is an integer with a magnitude such that the content of EO is from 70 to 90% by weight.

8. The composition of claim 1, further comprising:
a silicon dioxide, a pyrogenic silica, a precipitated silica, or any mixture thereof.

9. The composition of claim 8,
wherein a total content of the silicon dioxide, pyrogenic silica, precipitated silica, or mixture thereof is from 0.001% to 10% by weight in relation to the composition.

10. The composition of claim 1,
wherein the alkoxysilane or alkoxysilanes comprise at least one alkoxysilane of formula II selected from the group consisting of aminopropyltriethoxysilane, aminopropyltrimethoxysilan; aminopropylmethyldiethoxysilane, aminopropylmethyldimethoxysilane, 1-aminomethyltrimethoxysilane, 1-aminomethyltriethoxysilane, N—[N′-(2-aminoethyl)-2-aminoethyl]-3-amino-propyltrimethoxysilane, N—[N′-(2-aminoethyl)-2-aminoethyl]-3-aminopropyltriethoxysilane, 2-aminoethyltrimethoxysilane, 2-aminoethyltriethoxysilane, diaminoethylene-3-propyltrimethoxysilane, and diaminoethylene-3-propyltriethoxysilane.

11. A method for producing the composition of claim 1, the method comprising:
mixing the organosiloxane with the polyoxyalkylene block copolymer,
wherein the organosiloxane is an aqueous organosiloxane.

12. The method of claim 11,
wherein the polyoxyalkylene block copolymer comprises two different alkylene oxide groups of formula VI:
HO(EO)ᵥ—[Z]ᵣ—(EO)ᵥ—H (VI),
Z is —CH(CH₃)—CH₂—O—, —(CH₂)₃—O—, —(CH₂)₄—O—, or —CH(C₆H₆)—CH₂—O—,
EO is identical to Z,
each v independently is an integer with a magnitude such that a content of EO in the block copolymer is from 5 to 95 percent by weight and
r is an integer with a magnitude such that a molecular weight of Z is at least 450 g/mol.

13. The method of claim 12,
wherein r is an integer with a magnitude such that the molecular weight of Z is from 1700 to 1800 g/mol, and
each v independently is an integer with a magnitude such that the content of EO is from 70 to 90% by weight.

14. The method of claim 11, further comprising:
adding an aqueous dispersion of a pyrogenic or other silica, an aqueously dispersible pyrogenic or other silica, or a powder-form pyrogenic or other silica.

15. The method of claim 11, further comprising:
applying the composition to a substrate, and
drying, crosslinking, or both drying and crosslinking,
wherein the applying comprises a single to four fold application per substrate, and
the method comprises the drying, crosslinking, or both drying and crosslinking after each application.

16. A method, comprising:
applying the composition of claim 1 to a substrate in need of treating, modifying, hydrophobizing, oleophobizing, dirt- and paint/ink-repellently treating, protecting, or any combination thereof.

17. The composition of claim 1,
wherein the alkoxysilane or alkoxysilanes comprise at least one alkoxysilane of formula III selected from the group consisting of tridecafluoro-1,1,2,2-tetrahydrooctyl-1-trimethoxysilane, tridecafluoro-1,1,2,2-tetrahydrooctyl-1-triethoxysilane, 3,3,4,4,5,5,6,6,7,7,8,8,9,9,10,10,10-heptadecafluorooctyltriethoxysilane, 3,3,4,4,5,5,6,6,7,7,8,8,9,9,10,10,10-heptadecafluorooctyltrimethoxysilane, 3,3,4,4,5,5,6,6,7,7,8,8,8-tridecafluorooctylmethyltriethoxysilane, 3-(1,1,2,2-tetrafluoroethoxy)propyltriethoxysilane, 3,3,4,4,5,5,6,6,7,7,8,8,8-tridecafluorooctylmethyltrimethoxysilane, and 3-(1,1,2,2-tetrafluoroethoxy)-propyltrimethoxysilane.

18. The composition of claim 1,
wherein the alkoxysilane or alkoxysilanes comprise at least one alkoxysilane of formula IV selected from the group consisting of dimethyldimethoxysilane, dimethyl-diethoxysilane, propylmethyldimethoxysilane, propylmethyldiethoxysilane and any corresponding propoxy-substituted silane.

19. The composition of claim 1,
wherein the alkoxysilane or alkoxysilanes comprise at least one alkoxysilane of formula V selected from the group consisting of methyltrimethoxysilane, methyltriethoxy-silane, ethyltrimethoxysilane, ethyltriethoxysilane, n-propyltrimethoxysilane, n-propyltriethoxysilane, n- or isobutyltrimethoxysilane, n- or isobutyltriethoxysilane, n- or isooctyltrimethoxysilane, n- or isooctyltriethoxysilane, hexadecyltrimethoxysilane, and hexadecyltriethoxysilane.

20. The method of claim 15, wherein the applying comprises spraying.
